(19) United States
(12) Patent Application Publication
(10) Pub. No.: US 2015/0170199 A1
(43) Pub. Date: Jun. 18, 2015

(54) INTERACTIVE CONSUMER ENGAGEMENT PLATFORM

(71) Applicant: Adformics, Inc., San Diego, CA (US)

(72) Inventor: Samuel Cho, San Diego, CA (US)

(21) Appl. No.: 14/105,160

(22) Filed: Dec. 12, 2013

(51) Int. Cl. G06Q 30/02; G06F 21/62

(52) U.S. Cl. CPC G06Q 30/0251; G06F 21/629

(57) ABSTRACT

A computer-implemented automated method adapted to provide access to gated content is described. The method includes: receiving a selection associated with a gated content item; providing an engagement user interface (UI) based at least partly on the received selection; determining whether a set of engagement criteria has been satisfied; and providing access to the gated content item if the set of engagement criteria has been satisfied. A computer-implemented automated method adapted to provide an engagement advertisement within a web page includes: presenting an engagement UI for a specified length of time; retracting the engagement UI to a specified location within the web page; cycles through a set of ads associated with the engagement advertisement; and determining whether a selection is made from the set of ads. A method receives an ad tag; parses the ad tag and assigns an ad unit to each campaign asset; and generates a code snippet.

### BACKGROUND OF THE INVENTION

The present invention is related to engagement of consumers through content provided using various sets of networks (e.g., the Internet or “world wide web”). Various consumers may be presented with a multitude of online content items including gated, or premium, content, advertisements or “ads” (e.g., banner ads, pop-up ads, etc.), etc. Such content items may be provided by various appropriate sources (e.g., content providers, ad servers, etc.).

Present solutions may allow consumers to ignore various advertisements (e.g., video and/or audio playback may be muted or moved to the background, users may quickly close or block pop-up windows or tabs, display ads may not draw attention, etc.).

Therefor there exists a need to present online advertising to consumers such that the consumers are engaged with the advertising content. In addition, there exists a need for a user-friendly, efficient way to provide access to gated content while engaging the consumer in the process. Furthermore, such a solution should utilize standard protocols and systems to implement various consumer engagement features that are scalable across multiple platforms and/or devices.

### BRIEF SUMMARY OF THE INVENTION

Some embodiments may provide a way for content providers to generate and deploy engagement elements. Such engagement elements may require user interaction in order to receive access to one or more content items such as premium content provided by a publisher or to engage with web-based advertising. Engagement elements may include, for example, games (e.g., shooting games, word-based games, puzzle games, etc.), multimedia (e.g., video content, photographic content, etc.), and/or other appropriate engagement features.

A content provider may be able to generate engagement elements with various appropriate characteristics (e.g., size, type of content, etc.). Such engagement elements may be associated with various existing advertising networks, ad formats, etc. The engagement elements may be able to automatically interact with external resources such as ad servers and/or content servers (e.g., via one or more application programming interfaces (APIs) using various commands, calls, messages, etc.).

The engagement elements may be deployed as snippets of code that are able to be embedded in various web pages (and/or other appropriate media). Alternatively, such engagement elements may be specified as a hypertext link, API call, and/or other appropriate way such that the engagement element is deployed based at least partly on live server-client interaction provided by some embodiments.

When a user loads a web page including one or more engagement elements, the user may be required to interact with an element in various appropriate ways before access is granted to premium content. Alternatively or conjunctively, such engagement elements may allow a user to interact with display ads presented in a web page.

A first exemplary embodiment provides a computer-implemented automated method adapted to provide access to gated content. The method includes: receiving a selection associated with a gated content item; providing an engagement user interface (UI) based at least partly on the received selection; determining whether a set of engagement criteria has been satisfied; and providing access to the gated content item if the set of engagement criteria has been satisfied.

A second exemplary embodiment provides a computer-implemented automated method adapted to provide an engagement advertisement within a web page. The method includes: presenting an engagement user interface (UI) for a specified length of time; retracting the engagement UI to a specified location within the web page; cycling through a set of ads associated with the engagement advertisement; and determining whether a selection is made from the set of ads.

A third exemplary embodiment provides a computer-implemented automated method adapted to generate an engagement element for inclusion within a web page. The method includes: receiving an ad tag associated with a set of campaign assets; parsing the ad tag and assigning an ad unit to each campaign asset from the set of campaign assets; and generating, for each ad unit, a code snippet to implement the engagement element.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIG. 1 illustrates a schematic block diagram of a conceptual hardware system provided by some embodiments of the invention;

FIG. 2 illustrates a schematic block diagram of a conceptual software system provided by some embodiments;

FIG. 3 illustrates a flow chart of a conceptual process used by some embodiments to generate an ad tag;

FIG. 4 illustrates a flow chart of a conceptual process used by some embodiments to generate engagement code;

FIG. 5 illustrates a flow chart of a conceptual process used by some embodiments to link engagement code to a set of advertisements;

FIG. 6 illustrates a flow chart of a conceptual process used by some embodiments to provide a first mode of user engagement;

FIG. 7 illustrates a flow chart of a conceptual process used by some embodiments to provide a second mode of user engagement;

FIG. 8 illustrates a message flow diagram of a conceptual communication scheme used by some embodiments to provide various modes of user engagement;

FIGS. 9-11 illustrate various exemplary user interfaces associated with the first mode of user engagement;

FIGS. 12-14 illustrate various exemplary user interfaces associated with the second mode of user engagement; and

FIG. 15 conceptually illustrates a schematic block diagram of a computer system with which some embodiments of the invention may be implemented.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features.

Broadly, embodiments of the present invention generally provide a way for content providers and/or advertisers to engage consumers who access web-based content.

Several more detailed embodiments of the invention are described in the sections below. Section I provides a conceptual description of a system provided by some embodiments. Section II then describes various operating schemes used by some embodiments. Next, Section III describes various exemplary user interfaces that may be provided by some embodiments. Lastly, Section IV describes a computer system which implements some of the embodiments of the invention.

### I. System

Sub-section I.A provides a conceptual description of a hardware architecture used by some embodiments. Sub-section I.B then describes a conceptual software architecture used by some embodiments. The systems described below are for example purposes only and different embodiments may be implemented with different combinations of hardware elements and/or different combinations of software elements, as appropriate. Such systems will typically include multiple hardware devices (e.g., a mobile device, a personal computer or “PC”, etc.), where each device may execute appropriate software (e.g., a web browser, server software, etc.).

A. Hardware Architecture

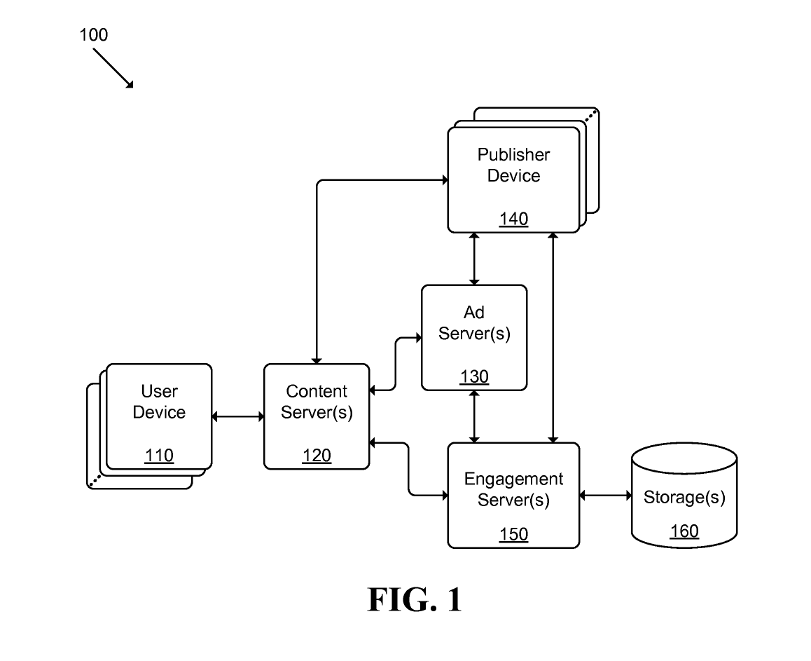

FIG. 1 illustrates a schematic block diagram of a conceptual hardware system 100 provided by some embodiments of the invention. Specifically, this figure shows the various elements and communication pathways that may be included in such a system. As shown, the system may include one or more user devices 110, one or more content servers 120, one or more ad servers 130, one or more publisher devices 140, and one or more engagement servers 150 with associated storage(s) 160.

Each user device 110 may be any device capable of accessing an online server through one or more networks (e.g., local area wireless networks, wired networks, distributed networks, cellular networks, etc.). Such devices may include devices such as, for example, PCs, smartphones, tablet devices, laptops, etc.

Each content server 120 may be a device or set of devices capable of storing content (e.g., text, video, multimedia, etc.) and/or other data (e.g., user account information, links to external content, etc.) and providing the content to one or more users across one or more networks. Each content server may be accessed by a number of user devices 110 using, for instance, a web browser application (and/or other appropriate applications) and one or more network connections. The content servers 120 may be able to access various local or network ed storage (not shown).

Each ad server 130 may be a device or set of devices capable of storing advertising content, user information, etc. and may be accessible across one or more network connections. In some embodiments, the ad server(s) may provide advertising content (e.g., text, multimedia, etc.) to each of the content servers 120. The ad servers 130 may be able to access various local or network ed storage (not shown).

Each publisher device 140 may be any device capable of accessing an online server through one or more networks (e.g., local area wireless networks, wired networks, distributed networks, cellular networks, etc.). Such devices may include devices such as, for example, PCs, smartphones, tablet devices, etc. In some embodiments, publisher devices 140 and user devices 110 may refer to similar devices that are associated with different types of system users. Publisher devices 140 may be used by content providers, advertising services, and/or other similar types of users. Thus, each publisher device may be able to access the content servers 120, ad servers 130, and engagement servers 150, while user devices 110 may be limited to accessing the content servers 120 (which may still allow these users to indirectly access other system elements via the content servers).

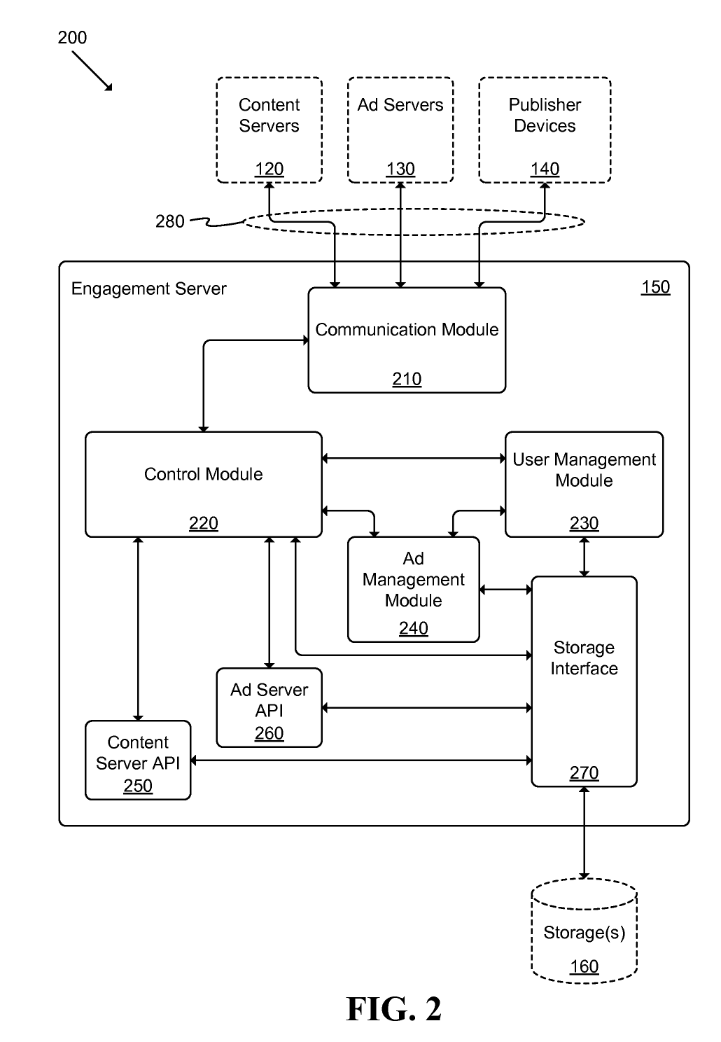

The set of engagement servers 150 may be implemented using one or more devices capable of processing data and/or instructions. The engagement servers may be able to access one or more local or network ed storage 160. The functional characteristics of the engagement servers 150 will be described in more detail in reference to FIG. 2 below.

During a typical operation scenario, system 100 may allow a publisher (via a publisher device 140) to generate content that is able to be reached via the content server 120. The publisher (and/or other appropriate entity) may then generate various ads and/or engagement elements using the ad server 130 and/or engagement server 150. Alternatively, the ads may be retrieved automatically from an ad exchange and/or other appropriate service. Likewise, the engagement elements may be retrieved and/or generated automatically by the engagement server 150. The engagement elements may then be embedded into the content that is able to be accessed via user devices 110. Such elements may use standard units (e.g., units established by the Interactive Advertising Bureau or “IAB”) or may be customized to meet various criteria established by the publishers, users, and/or other appropriate parties.

When a user (via user device 110) accesses content provided by the content servers 120, various ads may be automatically retrieved from the ad servers 130. Some such ads may include references to engagement elements that may be automatically retrieved from (and/or provided by) the engagement server 140. Such operation will be described in more detail in Section II below.

One of ordinary skill in the art will recognize that although system 100 has been described by reference to various specific examples and/or details, the system may be implemented in various different ways without departing from the spirit of the invention. For instance, some embodiments may include additional elements (e.g., entities that may collect ads from various ad servers and provide the ads to one or more content servers) and/or some embodiments may include fewer elements (e.g., a merged set of content and ad servers). In addition, such a system may be implemented using various combinations of hardware elements and software elements, as appropriate.

B. Software Architecture

Some embodiments may be implemented at least partly using various software elements, systems, interfaces, etc. Different embodiments may utilize different combinations of code (e.g., HTML code, scripting code, tags, etc.) that may be executed by an appropriate application such as a web browser.

Such code may include, for instance, various calls, messages, commands, etc. that may be selectively sent to one or more external resources (e.g., from a client user device to a host server device, from a server device to a third party server device, etc.). The code may also include, for instance, the ability to receive and/or respond to various calls, messages, commands, data, etc. that may be received from an external resource.

FIG. 2 illustrates a schematic block diagram of a conceptual software system 200 provided by some embodiments. Specifically, this figure shows the software elements executed by some embodiments of the engagement server 150. As shown, system 200 may include a communication module 210, a control module 220, a user management module 230, an ad management module 240, a content server API 250, an ad server API 260, and a storage interface 270.

The components executed by the engagement server 140 may be able to access (and/or be accessed by) software components executed by hardware elements such as the content servers 120, ad servers 130, publisher devices 140, and/or storage 160. Such access may utilize various interfaces, networks, and/or other communication pathways 280.

The communication module 210 may allow the engagement server 150 to communicate with various external resources (e.g., third-party servers, user devices, etc.) across various appropriate pathways (e.g., wired and/or wireless networks, the Internet, etc.). One of ordinary skill in the art will understand that the communication module 210 is a conceptual element and some embodiments may provide, for example, an API (and/or other appropriate interface) and/or storage that are able to be accessed directly via the Internet.

The control module 220 may oversee the operations of the engagement server elements and may facilitate communication and/or otherwise control interaction among those elements. In addition, the control module may perform and/or direct various tasks associated with the operation of the engagement server 150 (e.g., retrieving stored data, controlling access of external elements, etc.).

The user management module 230 may evaluate some or all access requests and may be used to authenticate such requests before allowing the requested access. For instance, a publisher-user may be required to set up a user account having, for example, a username and password. The username and password may subsequently be required to access data associated with the user account of the publisher-user. Such authenticated access may be required before a user is able to generate and/or modify engagement elements, ads, etc. In contrast, a consumer-user may not be required to set up a user account and may access data (e.g., published engagement elements, ads, etc.) provided by the engagement server 150 without being able to generate or modify such elements. However, some embodiments may identify particular consumer-users in other appropriate ways (e.g., using cookies, based on a referring source, etc.).

The ad management module 240 may be adapted to manage advertising content. For example, the ad management module may allow a publisher-user to associate an engagement element with a set of ads provided by a third-party ad server. As another example, the ad management module may determine which ads and/or engagement elements may be provided to a consumer-user.

The content server API 250 may allow various third-party content servers 120 to access system data such as engagement elements, ads, etc. (and/or otherwise interact with the system). The ad server API 260 may allow various third-party ad servers 130 to access the system data (and/or otherwise interact with the system). In some embodiments, the APIs 250-260 may receive requests from external elements and automatically respond with the appropriate data (e.g., a content server may request an engagement element and the API may respond with the appropriate code). Alternatively, the API may send requests to external elements based on various appropriate criteria (e.g., data corresponding to various ads associated with an engagement element may be requested from an external ad server).

The storage interface 270 may allow various system elements to access and/or store data and/or instructions from and/or to storage 160. The storage interface 270 may allow access to local and/or network ed physical storage elements, as appropriate.

During operation, a publisher-user may access the engagement server to generate some engagement element and/or associate the element with one or more ads. A consumer-user may subsequently view content provided by the publisher-user (e.g., a web page) and may be presented with the generated engagement element as part of the published content. The operation of system 200 will be described in more detail in Section II below.

One of ordinary skill in the art will recognize that although system 200 has been described with reference to various specific details, the system may be implemented in various different ways without departing from the spirit of the invention. For instance, instead of the various components 210-270 described above, some embodiments may provide a single API that is accessible via the Internet and may allow external resources to access the engagement server 150 and/or the associated storage 160. As another example, different embodiments may include various additional modules or sub-elements. In addition, some embodiments may divide various modules or elements into a set of sub-elements and/or some embodiments may combine multiple modules or sub-elements into a single module or element.

### II. Operating Schemes

Sub-section II.A provides a conceptual description of the generation of engagement elements of some embodiments. Sub-section II.B then describes engagement of users with published engagement elements. Lastly, sub-section II.C describes a message flow used by some embodiments.

The exemplary processes, message flows, and operating schemes described below may be implemented using various physical devices or systems such as, for instance, system 100 or system 200 described above. Some of the operations may be implemented using only a sub-set of system elements, while other operations may be implemented using all system elements (and/or appropriate additional elements).

A. Generation of Engagements Elements

Engagement elements may include any facets of content that are adapted to require user engagement with content. For instance, some embodiments may allow a user to view premium content only after completing a game or puzzle. As another example, some embodiments may “supercharge” existing static display ads by including some or all of the ad content within an engagement element such as a game. Such engagement elements may include code that is automatically generated and which may refer to external elements (e.g., ads provided by third-party servers).

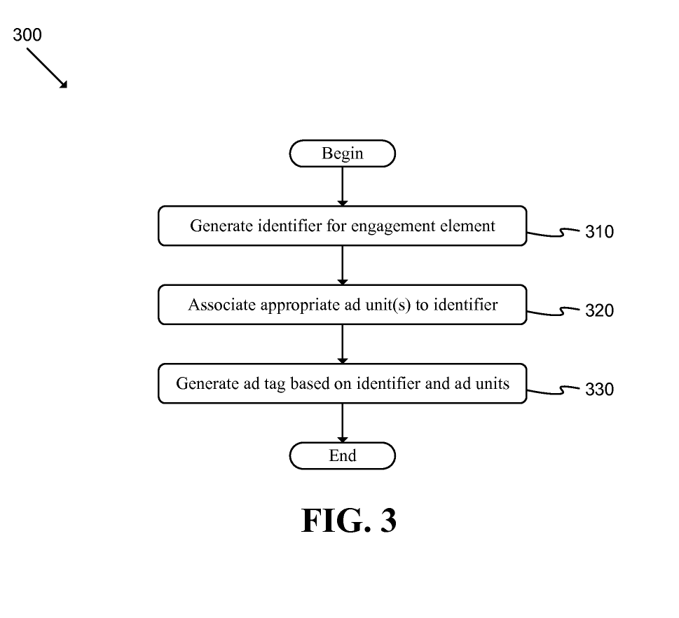

FIG. 3 illustrates a flow chart of a conceptual process 300 used by some embodiments to generate an ad tag. Such a process may begin, for instance, when a publisher-user accesses a system of some embodiments (e.g., by logging into an ad server).

As shown, the process may generate (at 310) an identifier for the engagement element to be created. Such an identifier may be generated in various appropriate ways (e.g., based on the publisher identity, based on time and/or date of creation, based on a random sequence of letters and/or numbers, etc.). Such an identifier may be formatted to comply with various appropriate standards (e.g., by including only alphanumeric characters, by including a specified number of characters, etc.).

Process 300 may then associate (at 320) an appropriate set of ad units to the identifier. Each ad unit may be specified by a vertical and horizontal number of pixels in some embodiments, and/or other appropriate ways. Such a set of ad units (or ad “sizes”) may be defined in various appropriate ways. For instance, a set of ad size selections may be received from the publisher-user. As another example, a set of ad sizes may be generated based on various parameters associated with the ad content (e.g., type of content, size or resolution of the content, etc.).

Next, the process may generate (at 330) an ad tag based at least partly on the identifier generated at 310 and/or the set of ad units associated with the identifier at 320. In some embodiments, the ad tag may include a set of parameters (e.g., ad unit selections, engagement element identifier, etc.). Alternatively or conjunctively, the ad tag may include a set of instructions or “code” (e.g., HTML code, script, etc.) and/or associated data that may be included by a publisher on a web page. The ad tag may be provided to the publisher, stored in a system-accessible storage, and/or otherwise made available for future use by a system of some embodiments. After generating (at 330) the ad tag, the process may end.

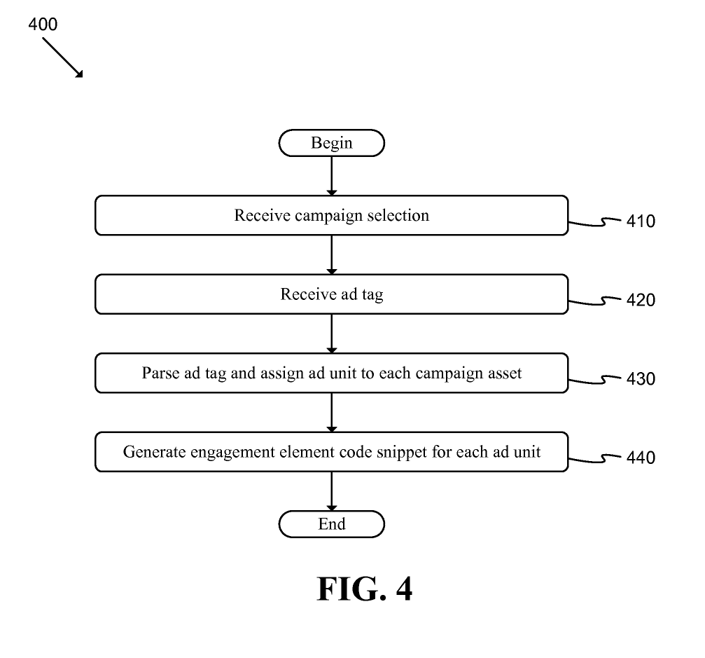

FIG. 4 illustrates a flow chart of a conceptual process 400 used by some embodiments to generate engagement code. Such a process may begin, for instance, when a publisher-user accesses a system of some embodiments (e.g., by logging into an engagement server). In some embodiments, process 300 may be performed before process 400 such that an ad tag is available. Alternatively, if no ad tag is available, process 400 may automatically generate such a tag.

Process 400 may then receive (at 410) a campaign selection. A campaign may define various sets of content, ad sources, specific advertisements, ad units, and/or other relevant parameters. Such a campaign may be created in various appropriate ways (e.g., based on received user selections, based on default parameters, etc.). The campaign selection may be received in various appropriate ways (e.g., a list of campaigns associated with a user may be presented to the user via a web interface, an active campaign may be automatically selected, etc.).

Next, the process may receive (at 420) an ad tag. Such an ad tag may have been generated using a process such as process 300 described above. In some embodiments, the ad tag may be associated with a specific set of ad servers (e.g., servers associated with a particular service for providing ads).

Process 400 may then parse (at 430) the ad tag and assign an ad unit to each asset associated with the campaign. Such ad units may be assigned from a list of potential ad units and may be assigned to each asset based on various relevant factors (e.g., type of asset, size or resolution of the asset, etc.). In some embodiments, the user may be able to preview the ad units and approve or modify each ad unit, as desired.

The process may then generate (at 440) an engagement element code snippet for each ad unit and then may end. Such code snippets may include data and/or instructions that are able to be interpreted by one or more elements (e.g., a browser running in a user device, a mobile device application, etc.). The code snippets may be provided to the user or stored to one or more system-accessible storage.

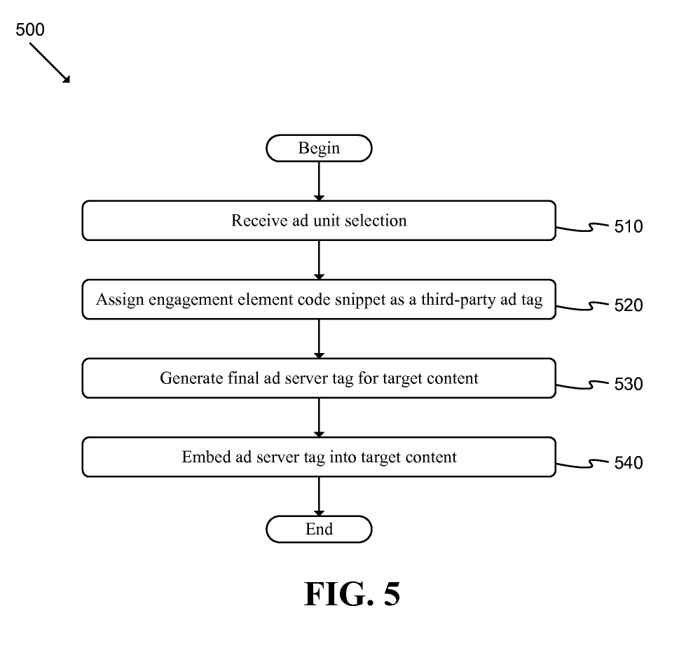

FIG. 5 illustrates a flow chart of a conceptual process 500 used by some embodiments to link engagement code to a set of advertisements. Such a process may begin, for instance, when a publisher-user accesses a system of some embodiments (e.g., by logging into an ad server).

As shown, the process may receive (at 510) an ad unit selection. Such a selection may be received in various appropriate ways (e.g., a user may make a selection from a list of available ad units, a user may specify an ad unit by dimension, etc.).

Next, the process may assign (at 520) an engagement element code snippet as a third-party ad tag for each selected ad unit. The process may then generate (at 530) a final ad server tag for the target content (e.g., the target web page). The final ad server tag may be generated automatically based at least partly on the ad unit selection received at 510, the engagement element code snippet assigned at 520, and/or other relevant factors.

Process 500 may then embed (at 540) the final ad server tag into the target content. Alternatively, the final ad server tag may be provided to a user for inclusion within the target content.

One of ordinary skill in the art will recognize that processes 300-500 are conceptual in nature and may be implemented in various different ways without departing from the spirit of the invention. For instance, different embodiments may include additional operations and/or perform a sub-set of the described operations. As another example, some embodiments may perform the operations in different orders than shown. In addition, such a process may be broken into a set of sub-processes, or implemented as a sub-process of a macro process. Furthermore, such a process (and/or sub-process thereof) may be performed iteratively until some set of criteria is met.

B. User Engagement

Once engagement elements have been generated the elements (and/or associated content) may be presented to a user in various appropriate ways. Some example user interfaces (UIs) will be described in Section III below. The modes of engagement described below may be associated with different types of content and/or presentation of content. For instance, a first mode may be used to allow access to premium content while a second mode may allow a user to engage with content via a display ad space.

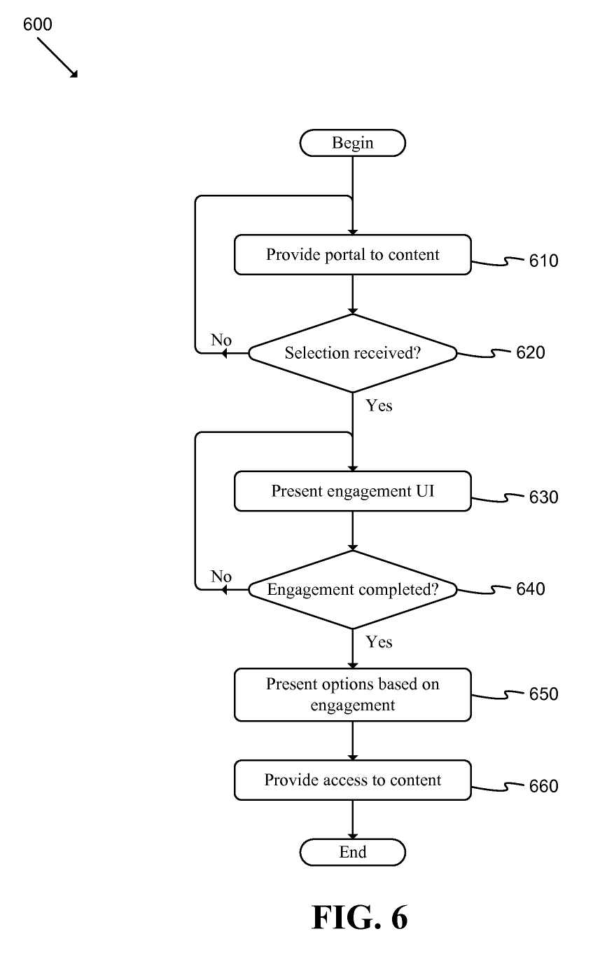

FIG. 6 illustrates a flow chart of a conceptual process 600 used by some embodiments to provide a first mode of user engagement. The first mode of user engagement may allow a publisher to require consumer-users to interact with an engagement element before providing access to premium or gated content. Such a process may begin, for instance, when a publisher-user publishes some content such that the content may be accessible to a set of consumer-users (e.g., by generating a publically accessible web page, by publishing the content to a forum, etc.).

As shown, the process may provide (at 610) a portal to the content (e.g., by presenting the content at a uniform resource locator or “URL”, by making the content available through a mobile device app, etc.). Next, the process may determine (at 620) whether a selection has been received. Such a determination may be made in various appropriate ways and may be based at least partly on actions taken by a particular consumer-user. For instance, such a selection may be made when a user selects a link associated with premium or gated content.

If the process determines (at 620) that no selection has been received, the process may iteratively perform operations 610-620 until the process determines (at 620) that a selection has been received.

After determining (at 620) that a selection has been received, the process may present (at 630) an engagement UI. Such an engagement UI may be presented in a separate browser tab, pop-up window, HTML overlay, etc. Some example UIs will be described below in Section III. The process may then determine (at 640) whether the engagement has been completed. Such a determination may be made in various appropriate ways and may be based at least partly on actions taken by a particular consumer-user in response to a presented engagement element. For instance, a user may have to complete a set of engagement tasks before access to the premium content is allowed.

If the process determines (at 630) that the engagement has not been completed, the process may iteratively perform operations 630-640 until the process determines (at 640) that the engagement has been completed.

If the process determines (at 640) that the engagement has been completed, the process may then present (at 650) options based at least partly on the engagement (e.g., based at least partly on the presented content, the actions taken by the consumer-user, etc.). Such options may include, for instance, links to external content (e.g., advertiser content), various selectable items such as re-deploying the engagement element, playing a video, continue to selected content, etc., and/or other appropriate elements such as coupons or other offers. Such options may be presented as selectable buttons within a web browser.

Depending on the selection from the options presented at 650, process 600 may perform various other appropriate actions (e.g., re-deploying an engagement element, launching a vendor website, etc.). In some embodiments, if no selection is made (and/or if a selection is made to access the premium content), the process may then provide (at 660) access to the premium content and then end. Such content may be provided via a web page or other appropriate ways.

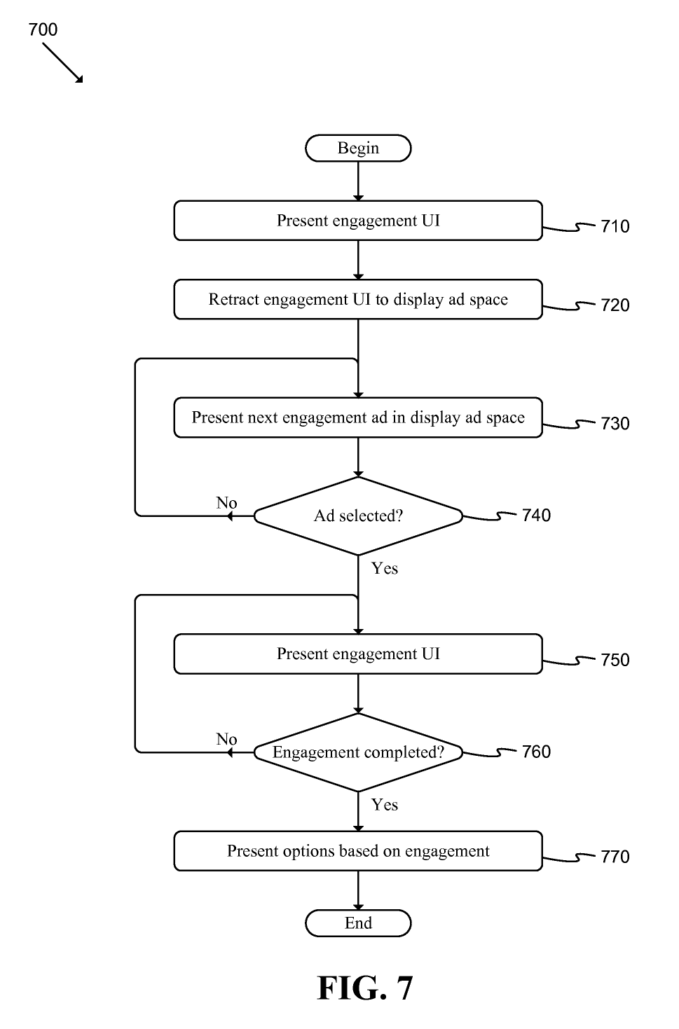

FIG. 7 illustrates a flow chart of a conceptual process 700 used by some embodiments to provide a second mode of user engagement. The second mode of user engagement may allow a publisher to automatically engage a user. Such a process may begin, for instance, when a consumer-user loads a web page having an appropriate engagement element.

As shown, the process may present (at 710) an engagement UI. Such an engagement UI may be presented as a pop-up window or web-page overlay when a user accesses a web page. If the engagement UI (or any sub-elements) is not selected by the user, the process may retract (at 720) the engagement UI to a display ad space (i.e., a space associated with at least one ad unit).

Process 700 may then present (at 730) the next engagement ad in the display ad space. For instance, some embodiments may associate a set of ads (e.g., three ads) with an engagement element and associated display ad space. Such ads may be provided by an ad server (e.g., based on a request for an ad of a certain size, based on a request for a specific ad, product, manufacturer, etc., and/or based on other relevant factors).

The process may then determine (at 740) whether an ad has been selected within an appropriate interval. Such a determination may be made in various appropriate ways (e.g., by determining that a user has clicked on the display ad location, clicked on a region within the display ad, etc.).

If the process determines (at 740) that no ad has been selected, the process may iteratively perform operations 730-740 until the process determines (at 740) that an ad has been selected. If the process determines (at 740) that an ad has been selected, the process may present (at 750) the engagement UI in a similar manner to that described above in reference to operation 710.

The process may then determine (at 760) whether the engagement has been completed. Such a determination may be made in various appropriate ways, as described above in reference to operation 640.

If the process determines (at 760) that the engagement has not been completed, the process may iteratively perform operations 750-760 until the process determines (at 760) that the engagement has been completed. If the process determines (at 760) that the engagement has been completed, the process may present (at 770) options based on the engagement in various appropriate ways, as described above in reference to operation 650. After presenting (at 770) the options, the process may end.

One of ordinary skill in the art will recognize that processes 600-700 are conceptual in nature and may be implemented in various different ways without departing from the spirit of the invention. For instance, different embodiments may include additional operations and/or perform a sub-set of the described operations. As another example, some embodiments may perform the operations in different orders than shown. In addition, such a process may be broken into a set of sub-processes, or implemented as a sub-process of a macro process. Furthermore, such a process (and/or sub-process thereof) may be performed iteratively until some set of criteria is met.

C. Communication Flow

When an engagement element is identified (e.g., when a web page is loaded), various system components may automatically interact to provide the engagement content to a consumer-user. Such interaction may involve calls and returns, and/or other forms of messaging. Such calls may be automatically made when, for instance, a web page is loaded.

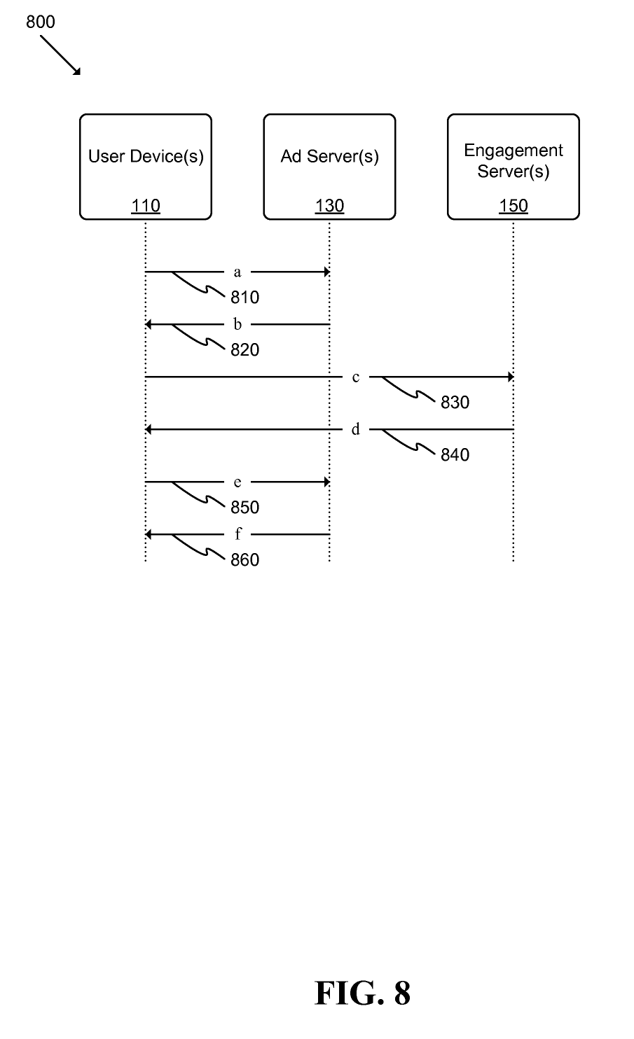

FIG. 8 illustrates a message flow diagram of a conceptual communication scheme 800 used by some embodiments to provide various modes of user engagement. In some embodiments, the messaging may be performed by elements such as the user device 110, ad server 130, and engagement server 140 described above in reference to FIG. 1.

Scheme 800 may be invoked, for instance, when a consumer-user loads a web page (e.g., a page provided by an element such as content server 120) that includes at least one engagement element. As described above, the engagement element may be activated in various appropriate ways (e.g., upon page loading, upon selection of content by a user, upon selection of an ad by a user, etc.).

Message ‘a’ 810 may include a call from the user device 110 to an ad server 130 using an ad tag associated with the web page. Such an ad tag may be generated using a process similar to process 500 described above. Next, message ‘b’ 820 may include a return of an ad that includes an engagement element ad tag. Such an ad tag may be generated using a process similar to process 300 described above.

Message ‘c’ 830 may include a call from the user device 110 to an engagement server 140 using an identifier associated with an engagement element. Such an identifier may be associated with the engagement element using a process similar to process 400 described above. Next, message ‘d’ 840 may include a return of an engagement ad that includes a set of ad server image tags. Such image tags may be provided by a service that provides the ads.

Message ‘e’ 850 may include a call from the user device 110 to the ad server 130 using the received image tag(s). Next, message ‘f’ 860 may include a return of ads and/or images associated with the image tags. In some embodiments, the ads may be specified by a publisher-user (e.g., specific ads or merchants may be selected and associated with the publisher content, a category of vendors may be specified, etc.) and/or may be determined at least partly by the ad server (e.g., a publisher-user may sign up for an ad service that automatically selects ads based on various factors such as type of publisher content, user preferences, etc.).

One of ordinary skill in the art will recognize that the communication scheme 800 described above may be implemented in various different ways without departing from the spirit of the invention. For instance, different embodiments may include different sets of messages which may be sent and/or received by different sets of system components.

### III. Exemplary User Interfaces

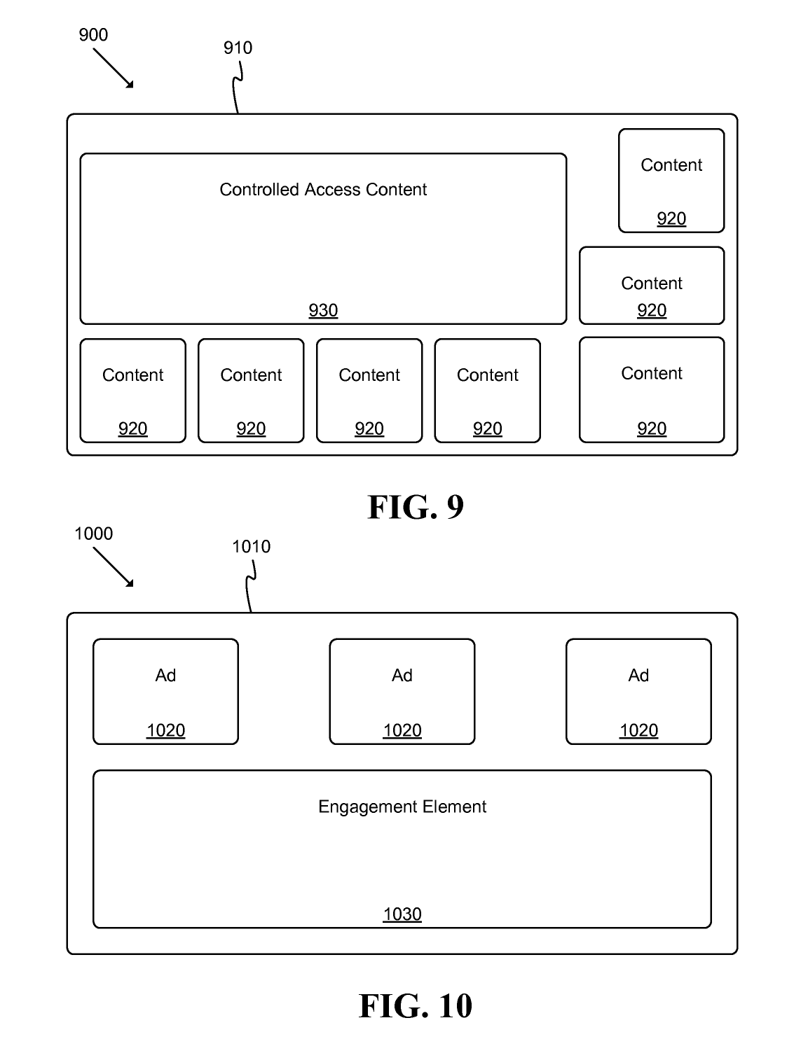

FIG. 9 illustrates an example user interface (UI) 900 associated with the first mode of user engagement described above in reference to FIG. 6. The UI may be presented within a web browser 910, which may include various controls, menus, etc. (not shown). The UI 900 may be associated with a web page that includes various content elements 920 and at least one controlled access content element 930. Each content element 920-930 may include various types of multimedia, for example, text elements, graphical elements, pictures, video, animation, audio, etc.

In this example, the UI 900 may represent a typical web site provided by an opinion magazine or other appropriate content provider. The provider may provide some content elements 920 without requiring any action by a user, but may control access to some content 930 such that a user has to fulfill some criteria to access the content. When a user selects the content 930, an engagement UI may be launched (e.g., in a separate window or tab, as an overlay to the web page 900, etc.).

FIG. 10 illustrates an example engagement UI 1000 provided by some embodiments. Such a UI may be presented using a web browser window 1010 and/or other appropriate elements (e.g., a user device app, a multimedia player, etc.). As shown, the engagement UI may include a set of ads 1020 and at least one engagement element 1030. The UI 1000 may include various other elements (e.g., banner ads, social media links, selection or termination buttons, etc.).

Each ad 1020 may be a typical display ad provided by an ad server. The ads may include various types of multimedia (e.g., images, text, graphic elements, video, audio, etc.). Such ads may typically be specified by size and may be scaled or otherwise modified for use within the UI 1000. The ads may be selected by a publisher-user when developing the engagement content, may be provided by an ad service, and/or may be selected in other appropriate ways.

The engagement element 1030 may include various types of engagement content. Some examples of engagement content include games (e.g., shooting games, word games, puzzles, etc.). The engagement content may require user interaction that depends on the type of content. For example, a user may have to reach a point threshold in an invaders game by destroying enemy ships before a base is destroyed. As another example, a user may have to perform a word search for terms associated with one or more products, advertisers, and/or other relevant groups. As another example, an image (e.g., a picture of a celebrity spokesperson, product, etc.) may be divided into sections and rearranged such that a user has to move the sections to their proper positions to view the image. In some embodiments, the display areas associated with the engagement content and the ads 1020 may overlap such that the ads themselves are part of the engagement (e.g., a user may be able to repeatedly shoot an ad to select the ad).

The engagement content may determine that the user has satisfied some interaction criteria (e.g., by scoring above a threshold number of points, assembling a puzzle, etc.) some embodiments may present a satisfaction UI. Alternatively, a user may be able to opt-out of the engagement (e.g., by clicking a button after a minimum amount of time such as five seconds, by directly selecting one of the displayed ads 1020, etc.).

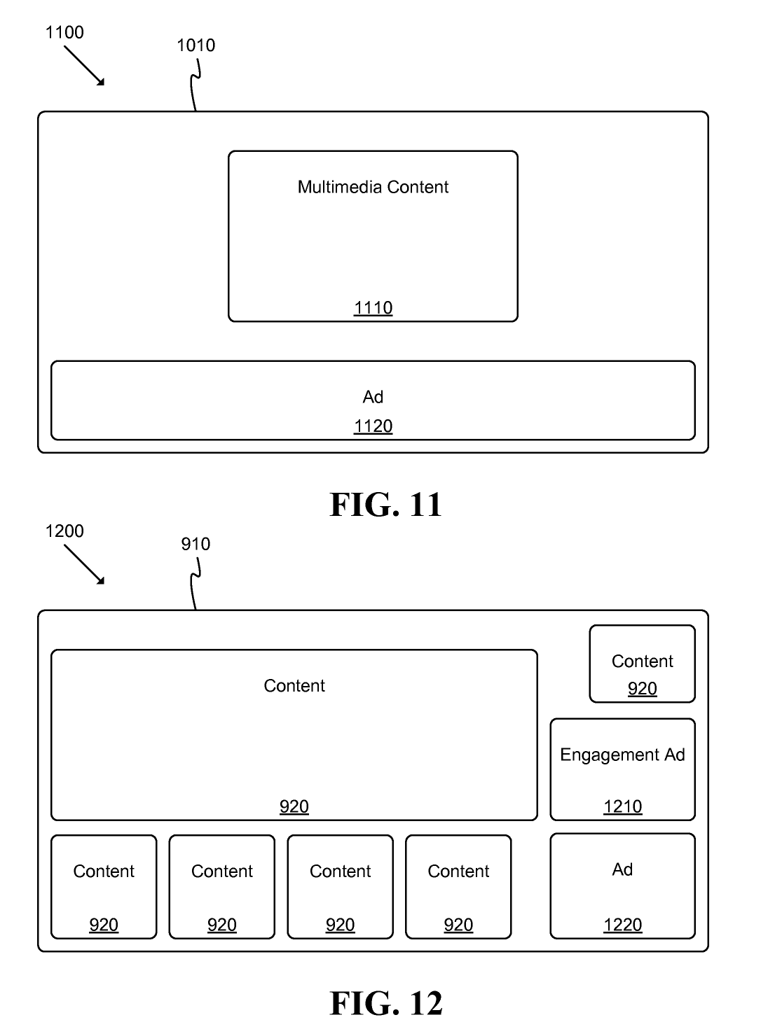

FIG. 11 illustrates an example satisfaction UI 1100. Such a UI may be presented using the web browser window 1010 and/or other appropriate ways. As shown, the UI 1100 may include multimedia content 1120 and an ad 1130. The multimedia content 1120 and/or ad 1130 may be selected based at least partly on the user interaction described above. The UI 1100 may include other appropriate elements such as selection buttons (e.g., “play again”, “watch the video”, a termination button, “continue to content”, etc.). In some embodiments, the multimedia content 1120 may begin playback when the UI 1100 is presented. Alternatively, a user may select playback using various selection elements provided by the UI 1100.

One of ordinary skill in the art will recognize that although the UIs 900-1100 have been described with reference to specific features, the UIs may be implemented in various different ways without departing from the spirit of the invention. For instance, the UIs may include differently shaped, sized, or otherwise differently arranged elements. In addition, the UIs may include various different specific elements (e.g., buttons, lists, menus, content, etc.) and/or numbers of elements. Furthermore, the UIs may be modified or optimized depending at least partly on a type of user device or access software.

FIG. 12 illustrates an example UI 1200 associated with the second mode of user engagement described above in reference to FIG. 7. As above, the UI may be presented within a web browser 910, which may include various controls, menus, etc. (not shown). The UI 1200 may be associated with a web page that includes various content elements 920, at least one engagement ad 1210 (or “supercharged” ad), and may include other ads 1220. Each content element 920 may include various types of multimedia, for example, text elements, graphical elements, pictures, video, animation, audio, etc.

Each engagement ad 1210 may be associated with an engagement element. Each ad 1220 may be a typical display ad provided by an ad server. The ads may include various types of multimedia (e.g., images, text, graphic elements, video, audio, etc.). Such ads may typically be specified by size and may be scaled or otherwise modified for use within the UI 1200. The ads 1210-1220 may be selected by a publisher-user when developing the content, may be provided by an ad service, and/or may be selected in other appropriate ways.

In some embodiments, upon loading the web page 1200, an engagement UI similar to UI 1000 may be presented for a specified length of time (e.g., a few seconds). During this time, a user may be able to engage the UI in a similar manner to that described above in reference to FIGS. 10-11. Alternatively, if the user does not engage the UI, the UI 1000 may retract to engagement ad space 1210.

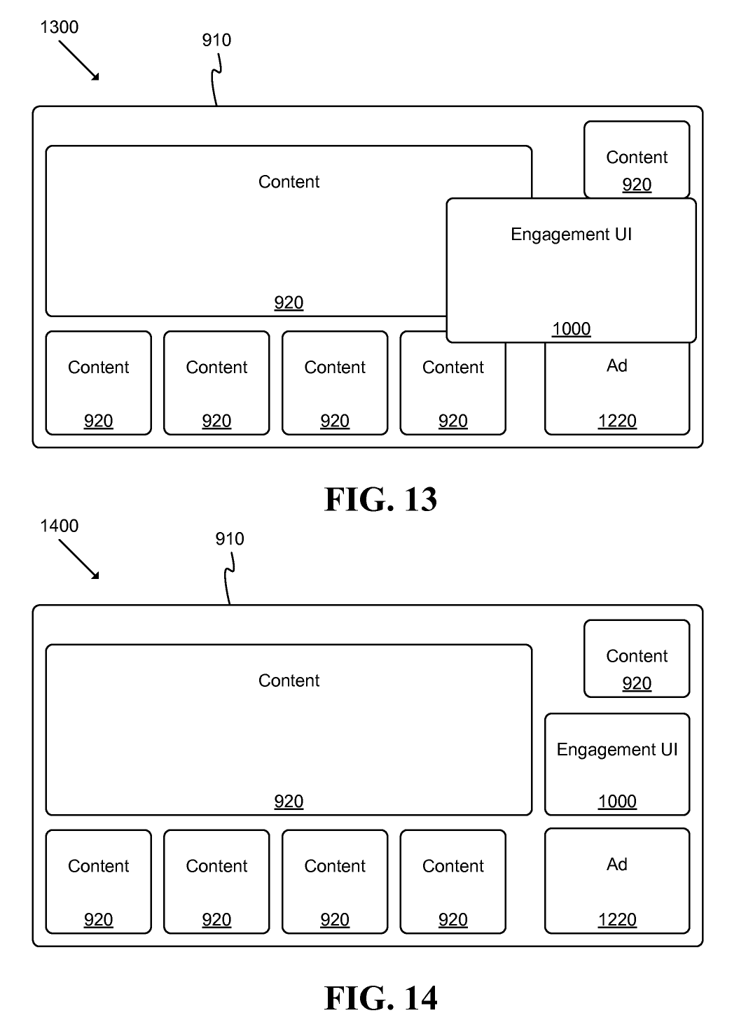

FIG. 13 illustrates an example UI 1300 that shows the engagement UI 1000 as the UI is being retracted to the engagement ad space 1210. FIG. 14 illustrates an example UI 1400 that shows the engagement UI 1000 after the UI has been refracted to the engagement ad space 1210.

After the engagement ad has been fully retracted, some embodiments may cycle through the set of ads associated with the engagement ad (e.g., by displaying each ad for ten seconds before moving to the next ad). If a user clicks on any of the associated ads, the engagement UI 1000 may be deployed as described above in reference to FIGS. 10-11.

One of ordinary skill in the art will recognize that although the UIs 1200-1400 have been described with reference to specific features, the UIs may be implemented in various different ways without departing from the spirit of the invention. For instance, the UIs may include differently shaped, sized, or otherwise differently arranged elements. In addition, the UIs may include various different specific elements (e.g., buttons, lists, menus, content, etc.) and/or numbers of elements. Furthermore, the UIs may be modified or optimized depending at least partly on a type of user device or access software.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, Digital Signal Processors (DSPs), Application-Specific ICs (ASICs), Field Programmable Gate Arrays (FPGAs), etc.) the instructions cause the computational element(s) to perform actions specified in the instructions.

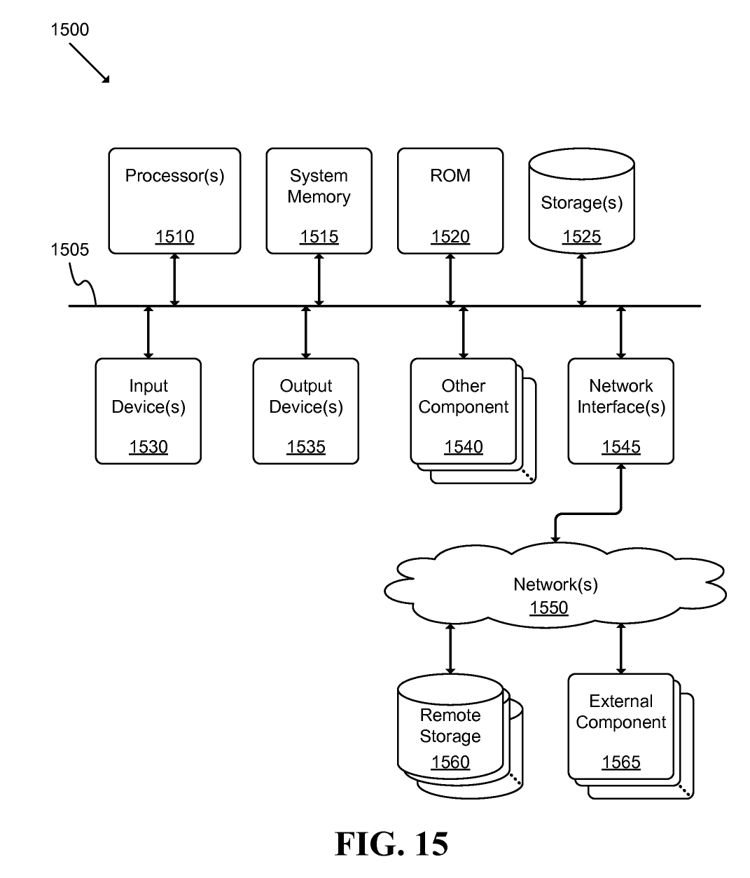

FIG. 15 conceptually illustrates a schematic block diagram of a computer system 1500 with which some embodiments of the invention may be implemented. For example, the system described above in reference to FIG. 1 may be at least partially implemented using computer system 1500. As another example, the processes described in reference to FIGS. 3-7 may be at least partially implemented using sets of instructions that are executed using computer system 1500.

Computer system 1500 may be implemented using various appropriate devices. For instance, the computer system may be implemented using one or more PCs, servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1500 may include at least one communication bus 1505, one or more processors 1510, a system memory 1515, a read-only memory (ROM) 1520, permanent storage devices 1525, input devices 1530, output devices 1535, various other components 1540 (e.g., a graphics processing unit), and one or more network interfaces 1545.

Bus 1505 represents all communication pathways among the elements of computer system 1500. Such pathways may include wired, wireless, optical, and/or other appropriate communication pathways. For example, input devices 1530 and/or output devices 1535 may be coupled to the system 1500 using a wireless connection protocol or system.

The processor 1510 may, in order to execute the processes of some embodiments, retrieve instructions to execute and/or data to process from components such as system memory 1515, ROM 1520, and permanent storage device 1525. Such instructions and data may be passed over bus 1505.

System memory 1515 may be a volatile read-and-write memory, such as a random access memory (RAM). The system memory may store some of the instructions and data that the processor uses at runtime. The sets of instructions and/or data used to implement some embodiments may be stored in the system memory 1515, the permanent storage device 1525, and/or the read-only memory 1520. ROM 1520 may store static data and instructions that may be used by processor 1510 and/or other elements of the computer system.

Permanent storage device 1525 may be a read-and-write memory device. The permanent storage device may be a non-volatile memory unit that stores instructions and data even when computer system 1500 is off or unpowered. Computer system 1500 may use a removable storage device and/or a remote storage device 1560 as the permanent storage device.

Input devices 1530 may enable a user to communicate information to the computer system and/or manipulate various operations of the system. The input devices may include keyboards, cursor control devices, audio input devices and/or video input devices. Output devices 1535 may include printers, displays, and/or audio devices. Some or all of the input and/or output devices may be wirelessly or optically connected to the computer system.

Other components 1540 may perform various other functions. These functions may include performing specific functions (e.g., graphics processing, sound processing, etc.), providing storage, interfacing with external systems or components, etc.

Finally, as shown in FIG. 15, computer system 1500 may be coupled to one or more networks 1550 through one or more network interfaces 1545. For example, computer system 1500 may be coupled to a web server on the Internet such that a web browser executing on computer system 1500 may interact with the web server as a user interacts with an interface that operates in the web browser. Computer system 1500 may be able to access one or more remote storage 1560 and one or more external components 1565 through the network interface 1545 and network 1550. The network interface(s) 1545 may include one or more application programming interfaces (APIs) that may allow the computer system 1500 to access remote systems and/or storage and also may allow remote systems and/or storage to access computer system 1500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1500 may be used in conjunction with the invention. Moreover, one of ordinary skill in the art will appreciate that many other system configurations may also be used in conjunction with the invention or components of the invention.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

It should be understood, of course, that the foregoing relates to illustrative details of exemplary embodiments of the invention and that modifications may be made without departing from the spirit and scope of the invention as defined by the following claims.

1. An automated method adapted to provide access to gated content, the method performed by a user device comprising a processor, the method comprising:
receiving a selection associated with a gated content item;
providing an engagement user interface (UI) based at least partly on the received selection;
determining, using the processor, whether a set of engagement criteria has been satisfied; and
if determining that the set of engagement criteria has been satisfied, providing access to the gated content item, or if determining that the set of engagement criteria has not been satisfied, denying access to the gated content item.

2. The automated method of claim 1, wherein the engagement UI comprises a set of advertisements.

3. The automated method of claim 1, wherein the engagement UI comprises a game.

4. The automated method of claim 1, wherein the set of engagement criteria comprises a minimum score.

5. The automated method of claim 1, wherein the gated content and the engagement UI are provided via a web browser.

6. The automated method of claim 1 further comprising denying access to the gated content item if the set of engagement criteria has not been satisfied.

7. The automated method of claim 1 further comprising providing access to a satisfaction UI if the set of engagement criteria has been satisfied.

8. A computer-implemented automated method adapted to provide an engagement advertisement within a web page, the method comprising:
presenting an engagement user interface (UI) for a specified length of time;
retracting the engagement UI to a specified location within the web page;
cycling through a set of advertisements associated with the engagement advertisement; and
determining whether a selection is made from the set of ads.

9. The computer-implemented automated method of claim 8, wherein the engagement UI comprises a set of advertisements and a game.

10. The computer-implemented automated method of claim 9, wherein the game comprises one of an invaders game, a word search game, and a puzzle game.

11. The computer-implemented automated method of claim 8 further comprising presenting the engagement UI if a selection is made from the set of advertisements.

12. The computer-implemented automated method of claim 8, wherein the set of advertisements is selected by a publisher-user.

13. The computer-implemented automated method of claim 8, wherein the set of advertisements is automatically provided by an ad server.

14. The computer-implemented automated method of claim 13, wherein each advertisement included in the set of advertisements is selected based at least partly on an analysis of the content provided within the web page.

15. A computer-implemented automated method adapted to generate an engagement element for inclusion within a web page, the method comprising:
receiving an ad tag associated with a set of campaign assets;
parsing the ad tag and assigning an ad unit to each campaign asset from the set of campaign assets; and
generating, for each ad unit, a code snippet to implement the engagement element.

16. The computer-implemented automated method of claim 15, wherein the ad tag is associated with an external ad server.

17. The computer-implemented automated method of claim 15, wherein the code snippet comprises script code that is able to be executed by a web browser.

18. The computer-implemented automated method of claim 15, wherein each ad unit comprises a set of dimensions.

19. The computer-implemented automated method of claim 15, wherein the engagement element includes a set of advertisements and an interactive element.

20. The computer-implemented automated method of claim 19, wherein the interactive element comprises one of an invader game, a word search, and a puzzle.
